(19) United States
(12) Patent Application Publication
(10) Pub. No.: US 2026/0070683 A1
(43) Pub. Date: Mar. 12, 2026

(54) Submerged Human Habitat System for Low-Gravity, Thin-Atmosphere Planetary Surfaces

(71) Applicant: Teweldemedhin Aberra Tegegne, Addis Ababa (ET)

(72) Inventor: Teweldemedhin Aberra Tegegne, Addis Ababa (ET)

(21) Appl. No.: 19/056,423

(22) Filed: Feb. 18, 2025

Related U.S. Application Data
(60) Provisional application No. 63/692,991, filed on Sep. 10, 2024.

(51) Int. Cl. B64G 99/00

(52) U.S. Cl. CPC B64G 99/00

(57) ABSTRACT

A submerged human habitat system for low-gravity, thin-atmosphere planetary surfaces includes an artificial waterbody, an ice-melting system, at least one habitat enclosure, and a boil-off cover. The artificial waterbody serves as a protective shield for the at least one habitat enclosure. The at least one habitat enclosure corresponds to living and working spaces for humans that are submerged in the artificial waterbody. The at least one habitat enclosure is designed to maintain a stable internal atmospheric pressure that matches the hydrostatic pressure from the surrounding artificial waterbody. The boil-off cover is a specialized, high-durability cover that surrounds the artificial waterbody to prevent boiling and evaporation. The boil-off cover ensures the stability of the submerged human habitat system. The ice-melting system provides a source of meltwater for the artificial waterbody from surrounding ice deposits.

### FIELD OF THE INVENTION

The present invention relates generally to planetary human habitats. More specifically, the present invention discloses a submerged human habitat system for planets with low gravity and thin atmospheres.

### BACKGROUND OF THE INVENTION

The natural gravity and atmosphere of Earth provide multiple benefits for human habitation, including protection from dangerous radiation, a stable climate, defense against meteorite impacts, a breathable air composition, as well as comfortable temperature and pressure levels. These habitable conditions are mostly not found on other planets that are the target of space exploration which makes space exploration a challenge. Building human habitats in low-gravity environments with thin or no atmosphere, such as the surfaces of the Moon or Mars, requires constructing habitats that replicate these habitable conditions. Various methods have been developed to address the challenge of building human habitats in low-gravity thin-atmosphere environments. Common approaches include building rigid enclosures with radiation shielding or terraforming the planetary environment into a habitable environment. Building rigid enclosures with radiation shielding relies on active systems to regulate temperature and pressure, but these systems suffer from low levels of passive safety. Terraforming involves a complex, long-term process of global climate engineering, which may not always be successful.

In contrast, the present invention discloses an alternative solution to the existing approaches by enabling the construction of human habitats with a high degree of passive safety. The present invention focuses on straightforward modifications to the immediate planetary environment, avoiding the complexities of full-scale terraforming or the vulnerabilities of entire artificial systems. In general, the present invention involves building enclosures submerged in water pools created by melting ice deposits on the planetary surface. The submerged building enclosure can include different structural designs depending on the mission requirements. In addition, a flexible or rigid cover is implemented over the water pool to prevent boil-off, while the water is maintained at a comfortable temperature using energy sources such as solar or nuclear power generators. Additional features and benefits of the present invention are further discussed in the sections below.

### SUMMARY OF THE INVENTION

The present invention discloses a submerged space habitat designed for human habitation in low-gravity thin-atmosphere environments, such as the surfaces on Mars or the Moon. The present invention provides a safe and stable living environment by utilizing a large artificial waterbody, such as a water pool, as a protective shield. The artificial waterbody serves multiple purposes including, but not limited to, passive radiation shielding, protection from meteorite impacts, temperature regulation, etc. In addition, the pressure inside the enclosure balances with the external water pressure, meaning the human habitat only needs to account for the variation in hydrostatic pressure across the vertical stretch of the human habitat. This pressure difference is greater at the bottom and lesser at the top. However, the key structural challenge comes from dynamic pressures, such as those caused by surface disturbances like meteorite impacts on the waterbody surface. In such scenarios, a flexible habitat enclosure would have an advantage, as the flexible habitat enclosure can flex and absorb pressure waves, whereas a rigid structure could crack or fail under the same stress. Further, the artificial waterbody is preferably a large, temperature-controlled water pool covered by a specialized boil-off cover. The boil-off cover can be either a rigid structure or a flexible structure depending on the environment conditions.

Moreover, habitable modules are submerged in the artificial waterbody, which is surrounded by the boil-off cover. Flexible boil-off covers are kept elevated off the artificial waterbody by vapor and other gases, creating a stable environment that prevents the waterbody from boiling or evaporating in the low-pressure planetary atmosphere. Further water supply for the artificial waterbody is continuously maintained by melting nearby ice deposits using different ice-melting systems including, but not limited to, solar-powered systems or nuclear-powered systems. This setup ensures a stable and long-term water supply, while the water also serves as a shield against cosmic radiation and micrometeorite impacts. Furthermore, the regulated water temperature ensures a comfortable living environment for the inhabitants.

### BRIEF DESCRIPTION OF THE DRAWINGS

FIG. 1 is a top-front-left perspective view of the submerged human habitat system of the present invention.

FIG. 2 is a top-front-right perspective view of the submerged human habitat system of the present invention.

FIG. 3 is a top view of the submerged human habitat system of the present invention.

FIG. 4 is a vertical cross-sectional view of the present invention taken along line 4-4 shown in FIG. 3.

FIG. 5 is a vertical cross-sectional perspective view of the present invention taken along line 5-5 shown in FIG. 3.

FIG. 6 is a schematic view of the ice-melting system of the submerged human habitat system of the present invention.

FIG. 7 is a box diagram of the electronic connections and the electrical connections of the present invention, wherein the electronic connections are shown in dashed lines, and wherein the electrical connections are shown in solid lines.

### DETAIL DESCRIPTIONS OF THE INVENTION

All illustrations of the drawings are for the purpose of describing selected versions of the present invention and are not intended to limit the scope of the present invention.

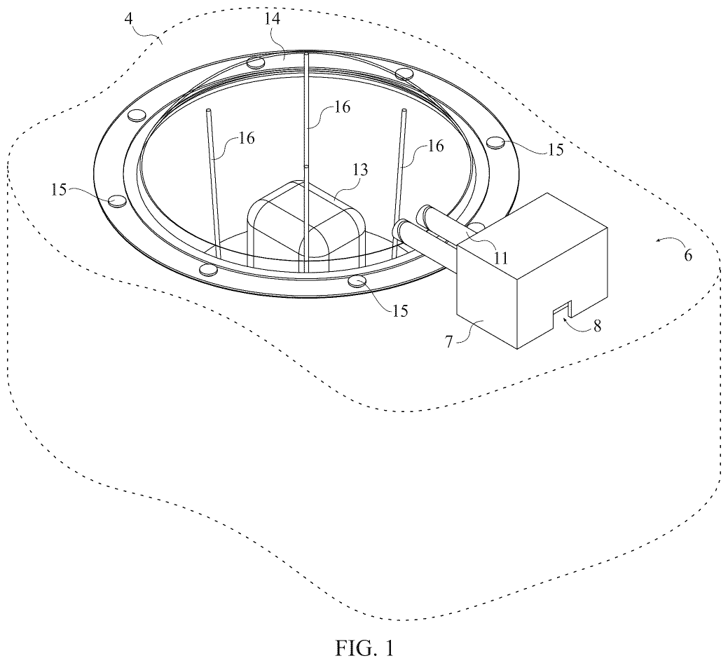

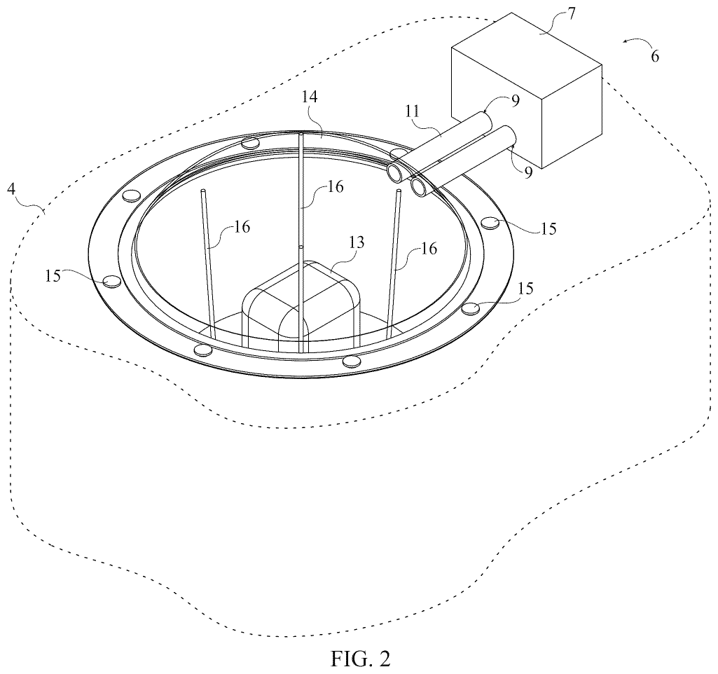

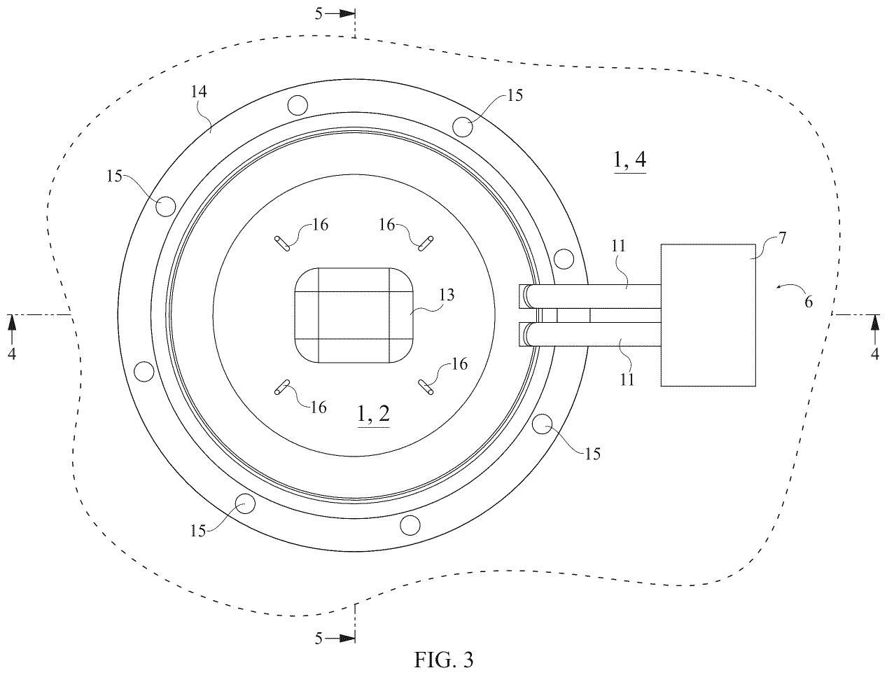

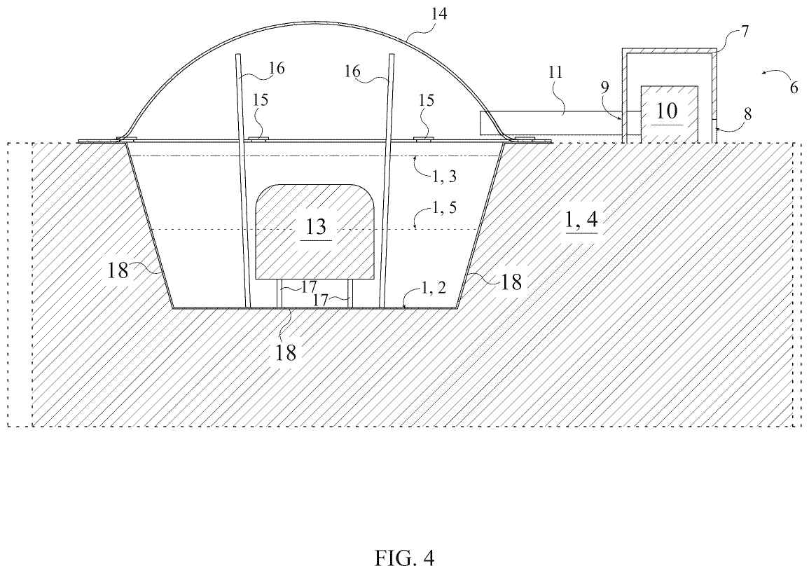

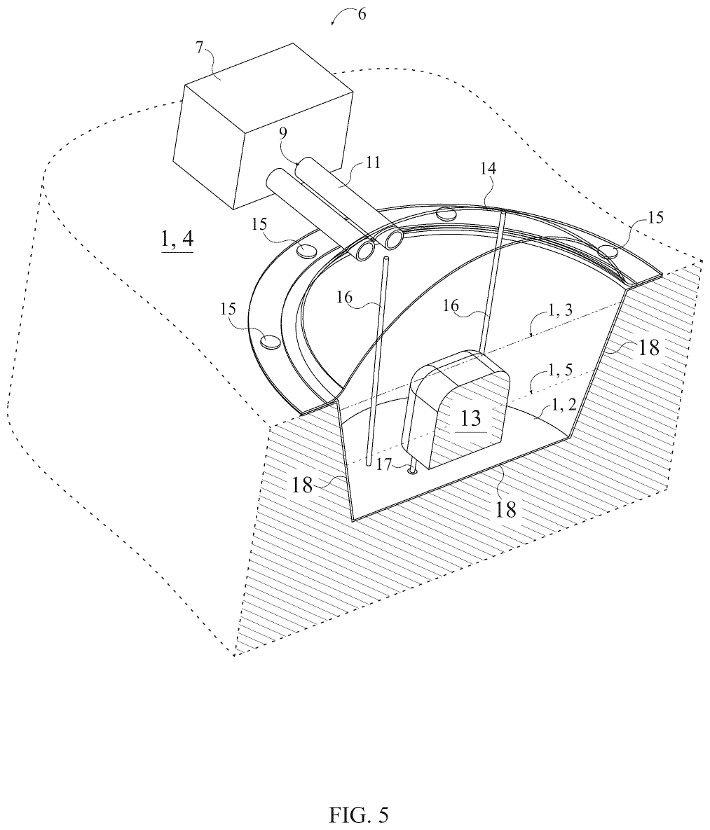

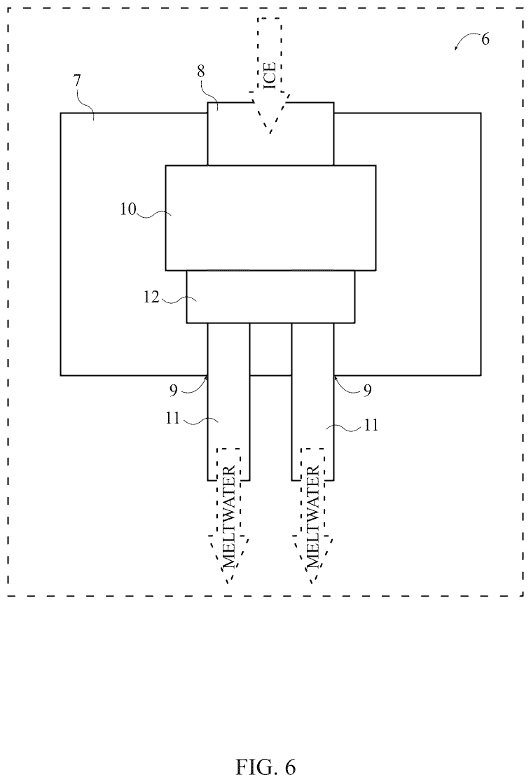

The present invention discloses a submerged human habitat system for low-gravity, thin-atmosphere planetary surfaces. In the preferred embodiment, the present invention comprises an artificial waterbody 1, an ice-melting system 6, at least one habitat enclosure 13, and a boil-off cover 14, as can be seen in FIG. 1 through 7. The artificial waterbody 1 serves as a protective shield for the at least one habitat enclosure 13. The at least one habitat enclosure 13 corresponds to living and working spaces for humans that are submerged in the artificial waterbody 1. The at least one habitat enclosure 13 is designed to maintain a stable internal atmospheric pressure that matches the hydrostatic pressure from the surrounding artificial waterbody 1. The boil-off cover 14 is a specialized, high-durability cover that surrounds the artificial waterbody 1 to prevent boiling and evaporation, ensuring the stability of the artificial waterbody 1. The ice-melting system 6 provides a source of water for the artificial waterbody 1 from surrounding ice deposits.

As previously discussed, the artificial waterbody 1 is a large, artificially created body of water sourced from melted ice deposits on the planetary surface. As can be seen in FIG. 1 through 7, the artificial waterbody 1 and the ice-melting system 6 are essential during construction and throughout ongoing operations to maintain the artificial waterbody 1 water levels. The continuous flow of meltwater ensures the stability and sustainability of the submerged human habitat system. Further, to optimize efficiency and reduce logistical challenges, the artificial waterbody 1 and the ice-melting system 6 are designed to be near each other to minimize the need to transport meltwater to the artificial waterbody 1 over large distances.

This proximity between the artificial waterbody 1 and the ice-melting system 6 reduces energy consumption, simplifies infrastructure, and decreases the potential for system failures associated with long-distance water transfer. Moreover, the location of the artificial waterbody 1 is primarily determined by the ease of establishing a suitable depression for the artificial waterbody 1. Selecting sites with natural depressions that require minimal, or no excavation work, is preferred. These natural basins reduce construction time and resource requirements, allowing for the rapid establishment of the artificial waterbody 1. As can be seen in FIG. 1 through 7, the artificial waterbody 1 generally comprises a waterbody floor 2, a waterbody surface 3, a waterbody shore 4, and an equilibrium point 5. The equilibrium point 5 is preferably a location positioned at a waterbody depth where a hydrostatic pressure on the at least one habitat enclosure 13 balances the internal air pressure within the at least one habitat enclosure 13. Further habitat design of the at least one habitat enclosure 13 can accommodate these site-specific conditions, ensuring functionality and safety to the inhabitants.

Submerging the at least one habitat enclosure 13 provides several benefits. The artificial waterbody 1 surrounding the at least one habitat enclosure 13 acts as an excellent radiation shield. Water is highly effective at absorbing harmful cosmic rays and solar radiation, which are prevalent on planetary surfaces with thin or no atmospheres. Unlike habitats that rely solely on solid shielding materials or active radiation protection systems, the water layer provides continuous, maintenance-free radiation shielding. This passive protection reduces the exposure of inhabitants to safe levels without the need for complex technology or constant monitoring. Further, the substantial thermal mass of the artificial waterbody 1 creates a stable thermal environment. Water has a high specific heat capacity, meaning that water can absorb and store large amounts of heat without significant changes in temperature. This property mitigates extreme temperature fluctuations that are characteristic of airless or thin-atmosphere planetary bodies. The passive thermal regulation reduces the energy requirements for heating and cooling systems, ensuring that internal temperatures remain within habitable ranges even if active climate control systems are compromised.

Further, the overlying water and structural covering offer robust protection against micrometeoroids and surface debris impacts. The water layer can absorb and dissipate the kinetic energy of small incoming particles, preventing penetration and damage to the at least one habitat enclosure 13. In the scenario of a breach of the boil-off cover 14 by a small asteroid or micrometeoroid, the design ensures that the habitats remain safe for a considerable time while repairs are conducted. The large volume of water acts as a buffer; any loss due to boil-off or evaporation is gradual, and the remaining water continues to provide radiation shielding and thermal stability. This gradual response affords the crew sufficient time to locate the breach, initiate repair protocols, and restore the integrity of the boil-off cover 14 without immediate threat to the habitants'safety. Additionally, the water exerts hydrostatic pressure on the submerged at least one habitat enclosure 13, which can be utilized to help maintain internal atmospheric pressure. The structural design can leverage this external pressure to balance internal and external forces, reducing mechanical stress on the walls of the at least one habitat enclosure 13 and minimizing the risk of decompression. In the event of minor breaches or leaks, the surrounding water pressure can help limit air loss, providing a buffer that allows time for repairs without catastrophic failure. Moreover, the submerged human habitat system design simplifies life support requirements by integrating natural resources. The water can be used for essential life support systems, including oxygen generation through electrolysis and as a source for potable water after appropriate treatment. This reduces dependence on resupply missions and active resource management systems, enhancing long-term sustainability and self-sufficiency.

In general, the present invention can be implemented as follows: the equilibrium point 5 is positioned between the waterbody floor 2 and the waterbody surface 3, which changes according to the volume of the artificial waterbody 1 and the design of the at least one habitat enclosure 13, as can be seen in FIG. 1 through 7. The at least one habitat enclosure 13 is submerged in the artificial waterbody 1 and is positioned adjacent to the equilibrium point 5. Further, the boil-off cover 14 is positioned external to the artificial waterbody 1 so that the boil-off cover 14 can be positioned over the waterbody surface 3. The boil-off cover 14 can be provided as a flexible boil-off cover 14 or as a rigid boil-off cover 14 depending on the environment and the design of the at least one habitat enclosure 13. Further, the boil-off cover 14 is perimetrically connected to the waterbody shore 4 so that the boil-off cover 14 is secured around the artificial waterbody 1. Moreover, the ice-melting system 6 is positioned external to the boil-off cover 14 so that the ice-melting system 6 can have access to the ice deposit. Furthermore, the ice-melting system 6 is in fluid-communication with the artificial waterbody 1 so that the meltwater from the ice-melting system 6 can flow into the artificial waterbody 1.

As previously discussed, the boil-off cover 14 is a key component in ensuring the stability and sustainability of the submerged at least one habitat enclosure 13 on a low-gravity planetary surface. As can be seen in FIG. 1 through 7, the boil-off cover 14 is preferably designed to prevent the evaporation of the artificial waterbody 1 and plays a vital role in maintaining the habitat's passive safety features. In a flexible embodiment, the boil-off cover 14 can be constructed from a lightweight, flexible material that is supported by the vapor pressure generated from the evaporating water of the artificial waterbody 1. In low-pressure environments, water tends to boil or evaporate at lower temperatures. By trapping the evaporated vapor beneath the boil-off cover 14, a saturated environment is created, which stabilizes the water in liquid form and prevents further boil-off into the thin atmosphere. The flexible boil-off cover 14 is also preferably transparent to allowing sunlight to penetrate the artificial waterbody 1 and contribute to the habitat's energy needs. Natural lighting supports the greenhouse effect within the submerged at least one habitat enclosure 13, reducing the need for external energy input, and enhancing the potential for plant growth. The natural solar input also helps maintain the water temperature, minimizing the demand for heating systems.

Further, as previously discussed, the flexible boil-off cover 14 is preferably supported by the internal vapor pressure from the artificial waterbody 1. The evaporating water creates a pressure beneath the flexible boil-off cover 14, allowing the flexible boil-off cover 14 to inflate and maintain the shape without the need for heavy or rigid supports. This vapor pressure provides the necessary structural stability, simplifying the construction and reducing the need for complex infrastructure. Moreover, the reliance on natural vapor pressure to maintain the form of the flexible boil-off cover 14 reduces the strain on external energy sources and enhances the system's passive safety features.

As can be seen in FIG. 1 through 7, to further support the flexible boil-off cover 14 and manage the shape, the present invention may include tethered anchors that secure the flexible boil-off cover 14 to the ground surrounding the artificial waterbody 1. So, the present invention may further comprise a plurality of shore anchors 15 and a plurality of water anchors 16 that secure the flexible boil-off cover 14 to the waterbody shore 4 and the waterbody floor 2, respectively. The plurality of shore anchors 15 is perimetrically distributed about the boil-off cover 14 to evenly distribute the plurality of shore anchors 15 around the waterbody shore 4. Further, the boil-off cover 14 is connected to the waterbody shore 4 using the plurality of shore anchors 15 to secure the flexible boil-off cover 14 to the waterbody shore 4. On the other hand, the plurality of water anchors 16 is distributed throughout the waterbody floor 2 to evenly distribute the plurality of water anchors 16 around the at least one habitat enclosure 13. Further, each of the plurality of water anchors 16 is tethered to the boil-off cover 14 to secure the flexible boil-off cover 14 to the waterbody floor 2.

As can be seen in FIG. 1 through 7, the plurality of shore anchors 15 and the plurality of water anchors 16 can be tethered to the flexible boil-off cover 14 using the appropriate anchor ropes. The anchor ropes help distribute the forces acting on the flexible boil-off cover 14, reducing the strain on any single point, and ensuring that the fabric of the flexible boil-off cover 14 does not become overstressed. In the event of a puncture or breach, the anchor ropes limit the spread of the damage by maintaining the structure of the flexible boil-off cover 14, allowing for timely repairs without jeopardizing the habitat's integrity. Thus, the plurality of shore anchors 15 and the plurality of water anchors 16 ensure that minor breaches do not result in immediate catastrophic failure, giving the crew sufficient time to address the issue. In other embodiments, different mechanisms can be utilized to secure the flexible boil-off cover 14 to the ground surrounding the artificial waterbody 1.

The flexible boil-off cover 14 allows the close integration with other habitat critical systems. The ice-melting system 6, for example, continuously supplies water to the artificial waterbody 1 by melting local ice deposits. The ability of the flexible boil-off cover 14 to trap vapor ensures that the meltwater remains in the system, contributing to the habitat's sustainability. Similarly, the at least one habitat enclosure 13, submerged in the artificial waterbody 1, relies on the flexible boil-off cover 14 to maintain the water layer that provides radiation shielding, thermal stability, and protection from impacts. Thus, the flexible boil-off cover 14 provides a passive solution to critical challenges such as radiation protection, thermal regulation, and water retention. The flexibility, vapor-supported structure, and integration with shading and support systems of the flexible boil-off cover 14 make the boil-off cover 14 a highly efficient and sustainable solution for long-term extraterrestrial habitation.

In an alternate embodiment, the boil-off cover 14 is provided as a rigid boil-off cover 14. The rigid boil-off cover 14 can be made from strong lightweight materials shaped into a dome structure or other appropriate structures. The rigid boil-off cover 14 provides enhanced resistance to wind and environmental stresses and offers greater durability over time, which makes the rigid boil-off cover 14 ideal for long-term, permanent installations. However, the construction of a rigid boil-off cover 14 is more complex compared to the flexible alternative, requiring supporting frameworks, anchors, and more intricate assembly processes. Despite these challenges, the rigid boil-off cover 14 offers the advantage of being able to integrate additional systems, such as solar panels for energy generation or insulation layers for improved thermal regulation. This makes the rigid boil-off cover 14 a robust option for environments with extreme conditions, provided that the construction and deployment complexities can be successfully overcome. In other embodiments, the boil-off cover 14 can be provided with different structures that combine flexible and rigid elements.

As previously discussed, the boil-off cover 14 serves a primary function in maintaining the integrity of the artificial waterbody 1 by preventing evaporation, but the utility can be expanded to cover a larger area, creating a controlled environment for various activities. Extending the coverage of the boil-off cover 14 beyond the artificial waterbody 1 can enhance the overall functionality of the habitat by creating a stable, usable atmosphere for additional purposes. For example, the extended coverage allows for the establishment of agricultural Zones. The controlled environment beneath the boil-off cover 14 can be optimized for plant growth, allowing the habitat to support self-sustaining agriculture. Sunlight, which is already allowed through the boil-off cover 14, can be used to promote crop production, while the enclosed atmosphere provides the necessary conditions for efficient plant growth. Further, the extended coverage allows for the establishment of scientific and industrial areas. Research, light manufacturing, or equipment assembly could be carried out in this extended area, where a more stable atmosphere is created. This would allow scientists and engineers to work without the need for pressurized spacesuits, improving mobility and reducing operational complexity. Furthermore, the extended coverage allows for maintenance and construction outside the at least one habitat enclosure 13. The extended area under the boil-off cover 14 provides a space for the maintenance of habitat infrastructure, equipment, or even additional construction. With a controlled atmosphere, repairs and assembly tasks can be performed with greater ease and efficiency.

Moreover, while the primary purpose of the boil-off cover 14 is to trap water vapor and prevent evaporation, the atmosphere under the boil-off cover 14 can be further enhanced by introducing additional gases such as oxygen, carbon dioxide, and nitrogen. This would allow the atmosphere to be suitable not only for preventing boil-off but also for supporting life and other activities. For example, introducing oxygen within the boil-off cover 14 would create a breathable atmosphere, enabling personnel to perform tasks without the need for full pressurized suits. This would significantly reduce the operational complexity of performing work outside the submerged at least one habitat enclosure 13. Further, adding carbon dioxide would enhance the potential for plant growth under the cover. By providing the necessary gas for photosynthesis, the atmosphere could support agriculture and contribute to the habitat's food production and oxygen recycling systems. Furthermore, nitrogen could be introduced to balance the atmospheric pressure within the boil-off cover 14, ensuring a safe and stable environment. This gas mixture would mimic Earth's atmospheric conditions, making the environment safer and more comfortable for long-term human activity.

Moreover, to avoid overheating, the boil-off cover 14 can be supplemented with adjustable shades and reflectors. A plurality of adjustable shades and a plurality of adjustable reflectors can regulate the amount of solar energy entering the system, providing a way to control the thermal environment of the artificial waterbody 1. The plurality of adjustable reflectors can be used to concentrate sunlight on areas that require additional heating, such as the ice-melting system 6, while the plurality of adjustable shades can block excess heat during peak solar hours. This balance ensures that the water temperature remains stable, and the habitat remains comfortable without over-relying on active heating systems. Both the plurality of adjustable shades and the plurality of adjustable reflectors can be mounted on either the internal surface or the external surface of the boil-off cover 14. In addition, a mechanical system or motorized system can be implemented on the boil-off cover 14 to enable the remote control of the plurality of adjustable shades and/or the plurality of adjustable reflectors.

The at least one habitat enclosure 13 is the core structure that provides the essential living and working space for inhabitants in the submerged human habitat system. The design of the at least one habitat enclosure 13 must consider the environmental forces exerted by the surrounding water, the challenges posed by low gravity, and the need for stability in a thin-atmosphere environment. A well-rounded design ensures long-term safety, comfort, and functionality while balancing structural demands with efficient resource use. As previously discussed, the at least one habitat enclosure 13 only needs to account for the variation in hydrostatic pressure across the vertical stretch of the at least one habitat enclosure 13. So, in some embodiments, the at least one habitat enclosure 13 can include a rigid floor for stability. A rigid floor is a crucial component that provides a stable foundation for the structure and for internal activities. The rigid floor must be capable of withstanding the forces exerted by both the weight of the at least one habitat enclosure 13 and the buoyant forces of the surrounding water. Moreover, a solid, leveled floor ensures that inhabitants can move around easily, and that equipment, furnishings, and life-support systems can be securely mounted. The rigid floor is also essential for distributing forces evenly across the base of the at least one habitat enclosure 13 and provides a secure platform for attaching the habitat to the ground. Materials used for the rigid floor including, but not limited to, reinforced concrete, composites, or high-strength alloys, must be strong enough to handle the pressure from both the water and the internal atmosphere. The rigid floor also helps counteract the buoyancy of the water, which would otherwise exert upward pressure on the at least one habitat enclosure 13.

Further, the at least one habitat enclosure 13 may include flexible and/or rigid walls. The choice between flexible and rigid walls depends on the functional requirements of the at least one habitat enclosure 13 and the environmental conditions of the site. Rigid walls provide structural integrity and protection from external forces such as water pressure, micrometeoroid impacts, and potential debris. Rigid walls also help to maintain the internal pressure of the at least one habitat enclosure 13, balancing the difference between the internal atmosphere and the external hydrostatic pressure. For long-term safety and stability, rigid materials like reinforced composites, titanium alloys, or other lightweight yet strong materials are commonly used. Further, rigid walls are ideal for areas where fixed infrastructure needs to be mounted, such as life-support systems, storage units, and scientific equipment. Rigid walls also offer better resistance to deformation over time, making rigid walls suitable for long-term habitation. In addition, rigid walls protect against sudden changes in external pressure or impacts, making the at least one habitat enclosure 13 more resilient.

As previously discussed, since the at least one habitat enclosure 13 only needs to account for the variation in hydrostatic pressure across the vertical stretch of the at least one habitat enclosure 13, a flexible habitat enclosure 13 would have an advantage, as the flexible habitat enclosure 13 can flex and absorb pressure waves. As such, flexible walls and the roof of the at least one habitat enclosure 13 may be used where weight savings are crucial or where ease of deployment is a priority. Flexible walls, constructed from durable synthetic materials or advanced polymers, could be utilized in areas that do not need as much structural rigidity. Flexible walls are advantageous for expandable modules or temporary sections of the at least one habitat enclosure 13. However, the flexible walls would require careful monitoring to ensure the flexible walls can maintain the pressure balance between the interior and exterior of the at least one habitat enclosure 13. While flexible walls might offer more adaptability, flexible walls are generally less resilient against external forces compared to rigid walls. In addition, flexible walls may require more frequent maintenance to prevent leaks or structural degradation.

A key challenge in the submerged human habitat system is ensuring that the at least one habitat enclosure 13 remains securely attached to the waterbody floor 2, particularly in the presence of buoyancy forces. Since the at least one habitat enclosure 13 is submerged, the water's buoyancy creates an upward force that could potentially lift the at least one habitat enclosure 13 if not adequately anchored. As can be seen in FIG. 1 through 7, the present invention may further comprise a plurality of enclosure anchors 17. Like the plurality of water anchors 16, the plurality of enclosure anchors 17 includes several tethered anchors that secure the at least one habitat enclosure 13 to the waterbody floor 2. To do so, the plurality of enclosure anchors 17 is distributed on the waterbody floor 2, adjacent to the at least one habitat enclosure 13, to position the plurality of enclosure anchors 17 below the at least one habitat enclosure 13. Furthermore, each of the plurality of enclosure anchors 17 is tethered to the at least one habitat enclosure 13 to secure the at least one habitat enclosure 13 to the waterbody floor 2.

In the preferred embodiment, to counteract buoyancy and ensure the at least one habitat enclosure 13 remains fixed in place, the enclosure anchors must be drilled deep into the waterbody floor 2. The enclosure anchors provide a solid foundation and prevent the at least one habitat enclosure 13 from being displaced due to the upward forces of buoyancy or lateral movements caused by ground instability. The enclosure anchors may consist of steel piles or composite rods that penetrate deep into the substrate, securing the at least one habitat enclosure 13 even in the case of minor ground shifts. Moreover, drilled anchors are essential in environments where the ground may not be stable or where the water pressure and buoyancy are significant. Drilled anchors are tethered to the base of the at least one habitat enclosure 13, providing a direct line of resistance to buoyant forces. The depth and placement of the enclosure anchors would be determined based on the ground composition, ensuring that the enclosure anchors penetrate far enough to reach stable soil or rock.

In addition to drilled anchors, mechanical anchoring systems can be used to further secure the at least one habitat enclosure 13. These could include, but are not limited to, bolts, pylons, or buried weights that are mechanically attached to the rigid floor or walls of the at least one habitat enclosure 13. These systems help distribute the stress exerted by buoyant forces evenly across multiple points, preventing localized stress at any one point. Further, tension cables or rods could also be incorporated, running from the base of the at least one habitat enclosure 13 to the drilled enclosure anchors or buried weights. These tension systems help keep the habitat taut and securely fastened to the waterbody floor 2, further reducing the risk of upward displacement due to buoyancy. The cables or rods would be designed to withstand the dynamic forces exerted by water pressure, buoyancy, and ground movement.

The buoyancy forces created by the surrounding water have a significant impact on the structural design of the at least one habitat enclosure 13, particularly in how the at least one habitat enclosure 13 is anchored to the waterbody floor 2. Buoyancy reduces the effective weight of the at least one habitat enclosure 13, meaning the structure naturally tries to float upward unless the at least one habitat enclosure 13 is securely anchored. Further, the attachment points between the at least one habitat enclosure 13 and the waterbody floor 2 are where most of the buoyant forces are concentrated. These points must be reinforced to withstand the upward pull exerted by the water, especially in a low-gravity environment where buoyant forces are amplified. Further, the overall design of the at least one habitat enclosure 13 must balance the weight of the at least one habitat enclosure 13 against the forces of buoyancy, ensuring that the structure remains stable. Using heavy ballast or adding mass to the rigid floor of the at least one habitat enclosure 13 can help counteract these forces. However, the upward forces still require robust anchoring systems to ensure that the structure does not shift or lift off the ground.

Moreover, the key to prevent stress failure at the attachment points is to distribute the load evenly across multiple anchors and supports. By spreading the buoyant force over several drilled enclosure anchors or tensioned cables, the stress on any single point is reduced, minimizing the risk of failure. The tension systems must be carefully engineered to ensure that the tension systems can handle the combined forces of buoyancy, water pressure, and any movement in the surrounding ground. Further, the materials used for the enclosure anchors and attachment points must be corrosion-resistant and capable of withstanding both upward buoyancy and lateral forces over time. High-strength alloys or composite materials are commonly used for these purposes, providing durability and resilience in the harsh, submerged environment.

In some embodiments, the present invention may further comprise a seepage-prevention lining 18. As can be seen in FIG. 1 through 5, the seepage-prevention lining 18 is superimposed over the waterbody floor 2 to ensure that the artificial waterbody 1 remains stable by preventing water from escaping into the surrounding ground. In environments like Mars or the Moon, water is a precious resource, and even minimal seepage could compromise the system's efficiency and sustainability over time. The seepage-prevention lining 18 provides an impermeable barrier between the artificial waterbody 1 and the underlying soil, maintaining water levels and contributing to the overall stability of the habitat. In the preferred embodiment, the primary function of the seepage-prevention lining 18 is to create a watertight barrier between the artificial waterbody 1 and the ground. The seepage-prevention lining 18 must be impermeable to water, durable, and capable of withstanding the varying pressures exerted by the artificial waterbody 1 and the surrounding ground. Common materials for seepage lining include, but are not limited to, synthetic geomembranes such as high-density polyethylene (HDPE), low-density polyethylene (LDPE), and reinforced polyethylene (RPE). These materials are chosen for flexibility, resistance to environmental degradation, and impermeability. If the seepage-prevention lining 18 is not used, the saturation of the surrounding soil can gradually reduce seepage rates. As the ground becomes saturated with water, the ground acts as a natural barrier, limiting further water loss into the substrate. While initial water losses may be higher until saturation is achieved, over time, this self-sealing effect can mitigate seepage. Monitoring soil saturation levels becomes an essential part of managing the water balance in such cases.

As can be seen in FIG. 1 through 5, the installation of the seepage-prevention lining 18 generally involves laying the lining material along the waterbody floor 2, ensuring the seepage-prevention lining 18 is secured properly to prevent any gaps. The edges of the seepage-prevention lining 18 may be anchored by mechanical means such as perimeter trenches and anchoring systems. The outer edge of the seepage-prevention lining 18 can be buried in trenches around the waterbody shore 4, securing the seepage-prevention lining 18 firmly in place. Additional weights or anchors (such as the plurality of shore anchors 15) may be placed strategically to prevent the seepage-prevention lining 18 from shifting or lifting due to water pressure or wind. The flexibility of the materials allows the seepage-prevention lining 18 to conform to the shape of the waterbody floor 2, ensuring a tight seal between the artificial waterbody 1 and the ground. Over time, the weight of the water in the artificial waterbody 1 presses the seepage-prevention lining 18 down, ensuring that the seepage-prevention lining 18 remains securely in place.

In some embodiments, the seepage-prevention lining 18 and the boil-off cover 14 can be provided as a single sealing structure. The single sealing structure simplifies the installation process and ensures seamless protection from both evaporation and seepage. In this embodiment, the boil-off cover 14, which prevents water from evaporating, can be stitched or fused to the seepage-prevention lining 18. As water fills the artificial waterbody 1 and the vapor pressure inflates the flexible boil-off cover 14, the seepage-prevention lining 18 is pressed firmly against the ground, creating a natural seal. Further, the weight of the water and the inflation of the boil-off cover 14 work together to hold the single sealing structure in place. This passive anchoring method reduces the need for additional mechanical securing methods, as the single sealing structure naturally conforms to the shape of the artificial waterbody 1. With both components combined into a single unit, the deployment of the system is more straightforward, reducing the complexity of on-site assembly. This is especially advantageous in remote environments like Mars, where human labor is limited. Furthermore, since the boil-off cover 14 and the seepage-prevention lining 18 are joined, there are fewer weak points or seams where water or vapor could escape, improving the overall durability of the system. While this integrated solution offers significant benefits in terms of ease of installation and maintenance, the single sealing structure requires careful material selection and precision in manufacturing to ensure long-term reliability.

For more standard installations, the seepage-prevention lining 18 and boil-off cover 14 can be installed separately. In this case, the seepage-prevention lining 18 is laid down first, followed by the boil-off cover 14, with each system performing the corresponding distinct role. In traditional setups, the seepage-prevention lining 18 is deployed and anchored independently using the appropriate shore anchors. The lining material is chosen for the impermeability and durability, and the installation may involve careful alignment and sealing of the edges to prevent leaks. Unlike the integrated embodiment, a separate seepage-prevention lining 18 requires more robust anchoring systems to prevent movement or shifting due to water pressure or environmental conditions. Mechanical anchors, perimeter trenches, and weighted edges are commonly used to ensure that the seepage-prevention lining 18 stays in place. Furthermore, in cases where the boil-off cover 14 and the seepage-prevention lining 18 are separate, each component must be monitored independently. While the boil-off cover 14 protects against evaporation, the seepage-prevention lining 18 must be checked for signs of wear, tear, or leaks. Regular inspections of both systems are crucial to ensure continued functionality.

Moreover, whether the seepage-prevention lining 18 is integrated with the boil-off cover 14 or installed as a separate system, the material selection is vital. Key factors to consider include, but are not limited to impermeability, flexibility, and durability. The lining material must be fully impermeable to water, ensuring that no seepage occurs through the ground. High-quality geomembranes, such as HDPE or RPE, are commonly used. Further, given the need to conform to the shape of the waterbody floor 2, the lining material must be flexible yet strong enough to withstand the pressures exerted by the water and ground. Furthermore, the materials used must be resistant to degradation caused by environmental factors such as UV radiation, temperature fluctuations, and potential chemical interactions with the soil or water.

In environments with uneven terrain or where the ground is less stable, additional anchoring techniques may be required to secure the seepage-prevention lining 18. For example, laying geotextile layers beneath the seepage-prevention lining 18 can help to stabilize the soil and prevent the seepage-prevention lining 18 from shifting. Geotextiles also provide an additional layer of protection against sharp rocks or debris that could puncture the seepage-prevention lining 18. In some cases, water-filled weights or ballast bags may be used to hold down the outer edge of the seepage-prevention lining 18, providing a passive, flexible means of securing the seepage-prevention lining 18. Furthermore, in areas with high winds or where the artificial waterbody 1 may experience pressure changes, tensioning systems can be used to ensure that both the seepage-prevention lining 18, and the boil-off cover 14 remain taut and securely in place.

As previously discussed, the ice-melting system 6 and the artificial waterbody 1 are physically separate from each other so that the ice-melting system 6 can access the ice deposits. The ice-melting system 6 is designed to be able to safely and efficiently operate in the low-gravity thin-atmosphere conditions of the planet. As can be seen in FIG. 1 through 7, the ice-melting system 6 may comprise a system housing 7 and an ice melter 10. The system housing 7 corresponds to the external structure that protects the ice melter 10, while the ice melter 10 corresponds to the mechanism that melts the deposits of ice. In addition, the system housing 7 comprises an ice inlet 8 and a water outlet 9, wherein the ice inlet 8 corresponds to the mechanism that allows the inflow of ice into the ice-melting system 6, and the water outlet 9 corresponds to the mechanism that allows the outflow of meltwater out of the ice-melting system 6. In general, the ice melter 10 is mounted within the system housing 7 so that the ice melter 10 is protected by the system housing 7. Further, the ice inlet 8, the ice melter 10, and the water outlet 9 are in fluid communication with each other to enable the flow into the ice-melting system 6 and meltwater out of the ice-melting system 6.

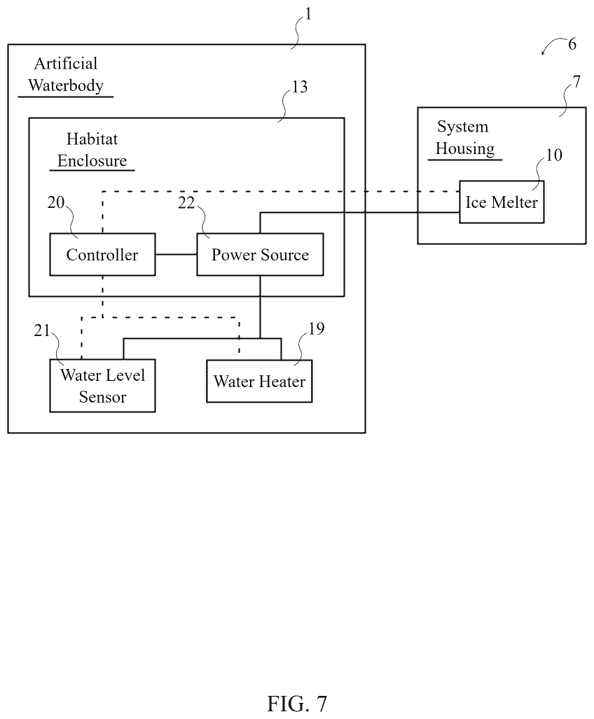

Both the artificial waterbody 1 and the ice-melting system 6 require a reliable heat supply to function effectively. The artificial waterbody 1 needs sufficient heat input to compensate for heat lost to the environment by maintaining the water in a liquid state at comfortable temperatures for habitation. As can be seen in FIG. 7, the present invention may further comprise a water heater 19 that helps maintain the artificial waterbody 1 at an optimal temperature. In some embodiments, the water heater 19 and the ice melter 10 can be part of the same heating mechanism using the same heat source. In other embodiments, the water heater 19 and the ice melter 10 can utilize different heat sources. Generally, the water heater 19 is positioned within the boil-off cover 14 so that the water heater 19 is in thermal conductivity with the artificial waterbody 1.

Different heat sources can be implemented according to the system's requirements, or the environmental conditions of the planet being inhabited. Generally, the heat source for the ice melter 10 and the water heater 19 can be provided as passive heat sources or active heat source. So, the ice melter 10 can be a passive ice melter 10 or an active ice melter 10. Similarly, the water heater 19 can be a passive water heater 19 or an active water heater 19. In environments with abundant solar radiation, the artificial waterbody 1 can be designed to maintain heat balance using a passive water heater 19 such as a mechanism that includes adjustable shades and mirrors. These passive elements capture and direct solar energy onto the waterbody surface 3, providing the necessary heat input. The configuration of shades and mirrors can be minimally adjusted over long periods to account for changes in solar intensity or seasonal variations, thus reducing the need for constant maintenance. Due to water's high specific heat capacity, the system does not require precise temperature regulation; maintaining an average heat balance over time is sufficient. The large thermal mass of the artificial waterbody 1 provides passive thermal stability, simplifying heating requirements and eliminating the need for complex control systems. By leveraging passive solar heating, the system reduces energy consumption and reliance on active heating methods.

In environments where sufficient solar radiation is not available, an active water heater 19 becomes necessary to maintain the desired water temperature. The active water heater 19 can be, but is not limited to, nuclear reactors, geothermal energy extractors, or other forms of power generation that produce heat as a byproduct. The heat generated can be transferred to the artificial waterbody 1 to compensate for environmental heat loss. While the active water heater 19 introduces additional energy requirements and system complexity, the high thermal mass of the artificial waterbody 1 still allows for stable temperatures with less frequent adjustments. The incorporation of an active water heater 19 ensures that the habitat remains functional and habitable even in conditions where a passive water heater 19 is insufficient.

On the other hand, the ice-melting system 6 requires concentrated and localized application of heat, especially when dealing with large ice deposits. Directly melting an entire ice deposit is impractical; therefore, the ice-melting system 6 focuses heat on specific areas to efficiently produce meltwater. Heat can be applied through various methods, such as deploying heating elements, utilizing focused solar mirrors, or harnessing waste heat from power generation systems. In environments rich in solar energy, a passive ice melter 10 such as a concentrated solar power mechanism can be particularly effective, directing sunlight onto precise points of the ice deposit to accelerate melting without additional energy sources. Conversely, in locations lacking sufficient solar radiation, an active ice melter 10 is essential for ice melting operations, ensuring a steady supply of meltwater to maintain the water levels of the artificial waterbody 1.

In embodiments where the heat source for both the water heater 19 and the ice melter 10 is shared, the overall system is arranged so that the artificial waterbody 1 and the ice-melting system 6 are positioned in close proximity. By keeping the ice-melting system 6 and the artificial waterbody 1 in close proximity, the energy efficiency of heat transfer and meltwater transport is maximized. The reduced distance not only saves energy but also lowers the complexity and maintenance needs of the infrastructure. Utilizing passive solar heating for both the water heater 19 and the ice melter 10 enhances the overall sustainability of the habitat in sun-rich environments. However, in situations where passive solar heating is insufficient due to limited solar radiation, the integration of active heating mechanisms is crucial. This flexibility allows the habitat to remain viable across a range of planetary environments, ensuring long-term human habitation on low-gravity, thin-atmosphere planetary surfaces.

Further, since the ice-melting system 6 and the artificial waterbody 1 are physically separate from each other, necessary structures need to be implemented, such as channels or pipelines, that transport the melted ice directly to the artificial waterbody 1. As can be seen in FIG. 1 through 6, the ice-melting system 6 may further comprise at least one fluid conduit 11. Depending on the terrain and specific site conditions, meltwater can flow downwards toward the artificial waterbody 1 due to gravity, further simplifying infrastructure and reducing energy requirements. In general, the at least one fluid conduit 11 is positioned external to the system housing 7 to connect the ice-melting system 6 to the artificial waterbody 1. The at least one fluid conduit 11 is also hermetically mounted through the boil-off cover 14 to prevent water vapor from escaping the boil-off cover 14. Further, the water outlet 9 is in fluid communication with the artificial waterbody 1 via the at least one fluid conduit 11 so that the meltwater can flow from the ice melter 10 to the artificial waterbody 1.

If elevation differences prevent gravity-fed flow of the meltwater, pumps can be employed, though keeping the systems nearby helps minimize the energy and maintenance demands associated with pumping. As can be seen in FIG. 1 through 6, the ice-melting system 6 may further comprise at least one fluid pump 12 that facilitates the fluid flow of the meltwater. In addition, the at least one fluid pump 12 is mounted within the system housing 7 so that the at least one fluid pump 12 is protected by the system housing 7. Further, the water outlet 9 is in fluid communication with the artificial waterbody 1 via the at least one fluid pump 12 so that the at least one fluid pump 12 aids in the fluid flow of the meltwater to the artificial waterbody 1.

Effective management of water balance is crucial for the sustainability of the submerged human habitat system. The water balance involves regulating the flow of meltwater from the ice-melting system 6 to the artificial waterbody 1 and accounting for losses due to evaporation, condensation, and seepage. Maintaining appropriate water levels ensures the structural integrity of the at least one habitat enclosure 13 and the efficiency of the system's protective features. As can be seen in FIG. 7, the present invention may further comprise a controller 20, at least one water level sensor 21, and a power source 22. The controller 20 helps monitor the operation of the system, while the power source 22 provides the electrical energy necessary for the operation of the system. The at least one water level sensor 21 helps monitor the meltwater levels on the artificial waterbody 1. Generally, the at least one water level sensor 21 is submerged into the artificial waterbody 1 so that the meltwater levels can be measured. In addition, the controller 20 and the power source 22 are mounted within the at least one habitat enclosure 13 to protect the controller 20 and the power source 22 from water damage. Further, the at least one water level sensor 21 and the ice-melting system 6 are electronically connected to the controller 20 to facilitate the monitoring of the operation of the system. Furthermore, the at least one water level sensor 21, the ice-melting system 6, and the controller 20 are electrically connected to the power source 22 to distribute the electrical power necessary for the operation of the system.

Consistent meltwater levels in the artificial waterbody 1 are essential for balancing the hydrostatic pressure with the internal atmospheric pressure of the submerged at least one habitat enclosure 13. A stable water level ensures minimal structural loads on the walls of the at least one habitat enclosure 13 and maintains the effectiveness of the water's protective features, such as radiation shielding and thermal regulation. Further, the continuous supply of meltwater from the ice deposit compensates for any water losses due to evaporation, seepage, or usage within the at least one habitat enclosure 13 (e.g., for life support systems). By carefully managing the rate of ice melting and water input, the system can adjust to varying rates of water loss and maintain the desired water level. Moreover, the water balance is closely linked with other submerged human habitat systems, including heating and life support. The heat supplied to maintain the artificial waterbody 1 temperature can influence evaporation rates, while water used within the at least one habitat enclosure 13 for consumption, hygiene, or agricultural purposes affects overall water availability. Efficient water recycling systems within the at least one habitat enclosure 13 reduce the demand for fresh water from the artificial waterbody 1, contributing to water balance maintenance.

The system design accounts for environmental factors that may impact water balance. Temperature fluctuations, solar radiation levels, and atmospheric conditions can affect evaporation and condensation processes. By incorporating adjustable passive heat systems like shades and mirrors, the submerged human habitat system can respond to these changes with minimal active intervention. Further, maintaining the water balance in the at least one habitat enclosure 13 is a critical but manageable task that ensures the long-term sustainability and functionality of the submerged human habitat system. In the initial stages of settlement, the focus is on the ease of setting up feasible and safe habitats. Rapid establishment is prioritized by utilizing nearby ice deposits and natural depressions to minimize construction time and resource expenditure. As settlements grow and develop self-sustaining economies, the emphasis gradually shifts toward water conservation. Implementing advanced water recycling systems within the submerged human habitat system, improving the efficiency of the ice melting process, and exploring methods to reduce water loss become key objectives to extend the lifespan of local water resources.

Over time, as nearby ice deposits begin to deplete, some submerged human habitat systems may face challenges in maintaining the proper water balance. To address this, the submerged human habitat systems might switch to transporting ice or water from more distant sources. This could involve developing infrastructure for long-distance water transfer, such as pipelines or transport vehicles. The feasibility of this approach depends on technological advancements and the economic capacity of the settlement. In some cases, if maintaining the water balance becomes unsustainable due to resource depletion or the impracticality of transporting water over long distances, submerged human habitat systems might need to be abandoned or relocated to areas with more abundant water resources. Planning for such contingencies is essential to ensure the safety and well-being of the inhabitants. Larger submerged human habitat systems may experience lower rates of water loss normalized to the size due to economies of scale. The greater volume of water in the artificial waterbody 1 increases the thermal mass, further stabilizing temperatures and reducing evaporation rates proportionally. Additionally, larger submerged human habitat systems can invest in more efficient technologies for water conservation and recovery, making larger submerged human habitat systems more sustainable in the long term.

Further, efficient and safe transport of goods, raw materials, waste, and personnel to and from the submerged at least one habitat enclosure 13 is a crucial aspect of the system's overall functionality. The unique environment of the submerged at least one habitat enclosure 13 requires specialized methods for transitioning between different areas, such as the habitat interiors, the surrounding water, the space beneath the boil-off cover 14, and the open planetary surface. In the preferred embodiment, the at least one habitat enclosure 13 is equipped with airlocks designed to facilitate movement between the at least one habitat enclosure 13 and the surrounding artificial waterbody 1. These airlocks maintain the internal atmospheric pressure and prevent water from entering the living spaces. Personnel can use these airlocks to exit the at least one habitat enclosure 13 for underwater activities, such as inspections or repairs of the exterior of the at least one habitat enclosure 13. The airlocks also serve as points for transferring goods and materials between the at least one habitat enclosure 13 and the water environment, using waterproof containers or sealed transport modules.

Another set of airlocks is installed to enable movement between the area beneath the boil-off cover 14 and the open planetary surface. These airlocks can be positioned around the perimeter of the artificial waterbody 1 or integrated into access points in the boil-off cover 14. These airlocks allow for the transfer of goods, equipment, raw materials, and waste without compromising the vapor barrier that prevents water evaporation. Personnel can use these airlocks when surface activities are required, such as setting up equipment, conducting scientific experiments, or exploring the surrounding terrain.

Moreover, transportation within the artificial waterbody 1 can be achieved by swimming or using small underwater vehicles. The low-gravity environment reduces the effort required for swimming, making swimming a viable option for personnel movement. Underwater propulsion devices or suits can enhance mobility and efficiency when traversing longer distances or carrying equipment. Further, the water medium provides a three-dimensional space for movement, allowing for flexible and efficient transport routes between several habitat enclosures or to specific points within the artificial waterbody 1.

Raw materials required for habitat operations, construction, or manufacturing processes are transported from the planetary surface or other habitats to the submerged facilities. Materials can be brought to the area beneath the boil-off cover 14 through the surface airlocks and then transferred underwater to the at least one habitat enclosure 13. Specialized containers that are waterproof and pressure-resistant are used to move raw materials through the artificial waterbody 1. These containers can be guided manually by personnel or transported using autonomous underwater vehicles. Waste management is an essential aspect of maintaining a sustainable habitat. Waste materials generated within the at least one habitat enclosure 13 are collected and processed internally as much as possible to recycle and repurpose usable components. Non-recyclable waste is packaged in sealed containers and transported out of the habitats through the airlocks. Waste can be moved to designated storage areas beneath the boil-off cover 14 or transported to the surface for disposal or further processing. In some cases, waste materials may be used as radiation shielding or for construction purposes outside the at least one habitat enclosure 13, reducing the need to transport the waste materials away from the site.

Further, most construction, material processing, and maintenance equipment are operated from within the at least one habitat enclosure 13. Remote-controlled robots, drones, and automated systems perform tasks outside the at least one habitat enclosure 13, reducing the need for personnel to venture into the artificial waterbody 1 or onto the surface. This approach minimizes human exposure to external hazards and enhances safety. Control centers within the at least one habitat enclosure 13 monitor and direct these operations, leveraging advanced communication and control technologies. The design philosophy emphasizes minimizing the need for humans to move out of the at least one habitat enclosure 13. By relying on automated systems and remote operations, personnel can perform necessary tasks without leaving the controlled environment of the at least one habitat enclosure 13. This reduces risks associated with exposure to radiation, extreme temperatures, or other environmental hazards present on low-gravity, thin-atmosphere planetary surfaces.

In emergency situations that require personnel to exit the habitats or the artificial waterbody 1 rapidly, specialized spacesuits may be made available. These suits are designed to function both underwater and in the vacuum or thin atmosphere of the planetary surface. These suits provide life support, thermal regulation, and protection from radiation. The suits enable personnel to swim through the artificial waterbody 1 and transition through airlocks to reach the surface if necessary. Emergency protocols are also in place to ensure swift and safe evacuation or access to critical areas during unforeseen events.

Further, the submerged habitat design streamlines construction by utilizing local resources and simplifying structural requirements. Melting in-situ ice deposits to create the artificial waterbody 1 reduces the need to transport large volumes of materials from Earth, significantly lowering mission costs and logistical challenges. The habitats can be assembled using modular, inflatable structures that are compact during transport and easily expanded on-site within the water environment. An important aspect of this design is the minimal structural requirement for covering the artificial waterbody 1. The boil-off cover 14 primary function is to prevent the water from boiling off into the thin atmosphere or vacuum. In low-pressure environments, water naturally evaporates or boils at lower temperatures. By enclosing the artificial waterbody 1, the vapor pressure from the evaporating water creates a saturated atmosphere just above the waterbody surface 3. This vapor pressure is sufficient to prevent further evaporation, establishing an equilibrium that maintains the water in liquid form.

Because the vapor pressure provides internal support, the boil-off cover 14 does not need to withstand significant external atmospheric pressures or structural loads. This allows for the use of lightweight, flexible materials such as fabrics or thin films to serve as the boil-off cover 14. These materials can be easily transported and deployed, further simplifying construction. The boil-off cover 14 can be anchored around the waterbody shore 4, requiring minimal structural support due to the internal vapor pressure balancing external forces. A key advantage of the submerged at least one habitat enclosure 13 is the ability to balance the hydrostatic pressure of the surrounding water with the internal atmospheric pressure of the at least one habitat enclosure 13. By carefully selecting the depth at which the at least one habitat enclosure 13 is submerged, the external water pressure can be matched to the internal air pressure required for human comfort. This balance dramatically reduces the structural loads on the walls of the at least one habitat enclosure 13, allowing for thinner and lighter construction materials. Combined with the low-gravity environment of bodies like the Moon or Mars, the structural loads can be even lower than those experienced by comparable structures on Earth. This reduction in load not only simplifies engineering requirements but also enhances safety by minimizing the risk of structural failure due to pressure differentials.

By integrating multiple protective functions into the water layer, such as radiation shielding, thermal regulation, and impact protection, the design reduces the need for separate, complex systems. This integration simplifies the submerged human habitat system overall architecture, decreasing the number of components that must be manufactured, transported, and assembled. Fewer systems also mean reduced maintenance requirements and lower potential for mechanical failures. The low-gravity environment facilitates the handling and assembly of modules of the at least one habitat enclosure 13. Components that would be heavy and cumbersome on Earth become manageable, allowing construction tasks to be performed more efficiently and with less physical strain on workers or robotic assemblers. The minimal atmosphere eliminates weather-related construction delays, enabling a more predictable and continuous building schedule. Utilizing available energy sources like solar or nuclear power to keep the water in liquid form incorporates thermal management into the submerged human habitat system's essential operations without the need for specialized heating equipment.

This synergy between habitat needs and environmental conditions further simplifies the construction process and reduces energy consumption. By focusing on in-situ resource utilization and multifunctional design elements, the submerged habitat concept offers a more practical and efficient approach to constructing human habitats on low-gravity, thin-atmosphere planetary surfaces. The minimal structural requirements for the boil-off cover and habitat walls reduce material needs and engineering complexity. This simplification not only makes the construction process more feasible but also enhances the sustainability and longevity of the habitat.

The simplified rapidly deployable design revolves around a seed settlement powered by a nuclear power plant and located near large, easily accessible ice deposits. This design approach enables the rapid establishment of a human settlement on extraterrestrial surfaces such as Mars or the Moon, providing essential life support and infrastructure for initial survival while laying the groundwork for future expansion into a more water-and-energy-efficient habitat. By using local resources and dual-use systems, the seed settlement provides the human resources, equipment, and infrastructure needed to build a more sustainable, long-term colony.

In the preferred embodiment, at the heart of the deployment is a nuclear power plant that provides steady, reliable power using direct heat-to-electricity conversion technologies, such as thermoelectric generators or thermionic converters. These systems convert the reactor's heat directly into electricity, offering a simple, robust energy source without complex mechanical components. Further, the excess heat generated by the nuclear reactor is used to rapidly melt nearby ice deposits, creating a large artificial waterbody 1 for life support systems, radiation shielding, and thermal regulation. This dual-use system maximizes efficiency by minimizing the need for separate systems for power generation and water processing. Further, the settlement is located at a site with large, accessible ice deposits, which can be quickly melted using the nuclear plant's excess heat. The meltwater forms the artificial waterbody 1 that serves multiple functions: the artificial waterbody 1 provides water for life support (drinking, oxygen generation, hygiene), radiation shielding, thermal stability, and micrometeoroid protection. In addition, the abundant ice supply eliminates the need for complicated water recycling or storage systems in the initial phases, enabling rapid deployment and immediate use of water for essential activities.

In the preferred embodiment, the seed settlement features modular, prefabricated habitat enclosures that are rapidly deployable and easy to assemble on-site. These habitats are submerged in the artificial waterbody 1, taking advantage of the water's radiation shielding and thermal regulation properties. The habitat enclosures are built with rigid or semi-rigid walls that can withstand the internal atmospheric pressure while benefiting from the water's protective functions. The simplicity and modularity of these habitat enclosures allow for quick setup, providing immediate shelter and life support for the settlement's crew. Then, a lightweight, flexible boil-off cover 14 is deployed over the artificial waterbody 1 to prevent evaporation. This cover traps water vapor, creating a saturated environment above the artificial waterbody 1, which minimizes water loss. Given the abundant ice supply, the system can tolerate small amounts of evaporation, reducing the need for intricate water conservation mechanisms in the early stages.

Further, the boil-off cover 14 may include transparent sections to allow natural sunlight into the habitat, supporting agricultural activities and reducing the energy needed for artificial lighting. With the seed settlement providing the necessary power and resources, the submerged human habitat system can gradually expand by adding new modular units that are more energy efficient. These units can integrate passive solar heating, energy-efficient insulation, and automated energy management systems that minimizes power consumption. Solar-driven greenhouses and solar thermal water heater 19s further contribute to reducing the energy footprint of the settlement while enhancing food production and water recycling capabilities.

Although the invention has been explained in relation to its preferred embodiment, it is to be understood that many other possible modifications and variations can be made without departing from the spirit and scope of the invention.

What is claimed is:

1. A submerged human habitat system for low-gravity, thin-atmosphere planetary surfaces comprising:
an artificial waterbody;
an ice-melting system;
at least one habitat enclosure;
a boil-off cover;
the artificial waterbody comprising a waterbody floor, a waterbody surface, a waterbody shore, and an equilibrium point;
the equilibrium point being positioned between the waterbody floor and the waterbody surface;
the at least one habitat enclosure being submerged in the artificial waterbody;
the at least one habitat enclosure being positioned adjacent to the equilibrium point;
the boil-off cover being positioned external to the artificial waterbody;
the boil-off cover being positioned over the waterbody surface;
the boil-off cover being perimetrically connected to the waterbody shore;
the ice-melting system being positioned external to the boil-off cover; and
the ice-melting system being in fluid-communication with the artificial waterbody.

2. The submerged human habitat system for low-gravity, thin-atmosphere planetary surfaces as claimed in claim 1, wherein the equilibrium point is positioned at a waterbody depth where a hydrostatic pressure on the at least one habitat enclosure balances an internal air pressure within the at least one habitat enclosure.

3. The submerged human habitat system for low-gravity, thin-atmosphere planetary surfaces as claimed in claim 1, wherein the boil-off cover is a flexible boil-off cover.

4. The submerged human habitat system for low-gravity, thin-atmosphere planetary surfaces as claimed in claim 1, wherein the boil-off cover is a rigid boil-off cover.

5. The submerged human habitat system for low-gravity, thin-atmosphere planetary surfaces as claimed in claim 1, wherein the boil-off cover and the seepage-prevention lining are a single sealing structure.

6. The submerged human habitat system for low-gravity, thin-atmosphere planetary surfaces as claimed in claim 1 further comprising:
a plurality of shore anchors;
the plurality of shore anchors being perimetrically distributed about the boil-off cover; and
the boil-off cover being connected to the waterbody shore using the plurality of shore anchors.

7. The submerged human habitat system for low-gravity, thin-atmosphere planetary surfaces as claimed in claim 1 further comprising:
a plurality of water anchors;
the plurality of water anchors being distributed throughout the waterbody floor; and
each of the plurality of water anchors being tethered to the boil-off cover.

8. The submerged human habitat system for low-gravity, thin-atmosphere planetary surfaces as claimed in claim 1 further comprising:
a plurality of enclosure anchors;
the plurality of enclosure anchors being distributed on the waterbody floor, adjacent to the at least one habitat enclosure; and
each of the plurality of enclosure anchors being tethered to the at least one habitat enclosure.

9. The submerged human habitat system for low-gravity, thin-atmosphere planetary surfaces as claimed in claim 1 further comprising:
a seepage-prevention lining; and
the seepage-prevention lining being superimposed over the waterbody floor.

10. The submerged human habitat system for low-gravity, thin-atmosphere planetary surfaces as claimed in claim 1 further comprising:
the ice-melting system comprising a system housing and an ice melter;
the system housing comprising an ice inlet and a water outlet;
the ice melter being mounted within the system housing; and
the ice inlet, the ice melter, and the water outlet being in fluid communication with each other.

11. The submerged human habitat system for low-gravity, thin-atmosphere planetary surfaces as claimed in claim 10, wherein the ice melter is a passive ice melter.

12. The submerged human habitat system for low-gravity, thin-atmosphere planetary surfaces as claimed in claim 10, wherein the ice melter is an active ice melter.

13. The submerged human habitat system for low-gravity, thin-atmosphere planetary surfaces as claimed in claim 10 further comprising:
the ice-melting system further comprising at least one fluid conduit;
the at least one fluid conduit being positioned external to the system housing;
the at least one fluid conduit being hermetically mounted through the boil-off cover; and
the water outlet being in fluid communication with the artificial waterbody via the at least one fluid conduit.

14. The submerged human habitat system for low-gravity, thin-atmosphere planetary surfaces as claimed in claim 10 further comprising:
the ice-melting system further comprising at least one fluid pump;
the at least one fluid pump being mounted within the system housing; and
the water outlet being in fluid communication with the artificial waterbody via the at least one fluid pump.

15. The submerged human habitat system for low-gravity, thin-atmosphere planetary surfaces as claimed in claim 1 further comprising:
a water heater;
the water heater being positioned within the boil-off cover; and
the water heater being in thermal conductivity with the artificial waterbody.

16. The submerged human habitat system for low-gravity, thin-atmosphere planetary surfaces as claimed in claim 15, wherein the water heater is a passive water heater.

17. The submerged human habitat system for low-gravity, thin-atmosphere planetary surfaces as claimed in claim 15, wherein the water heater is an active water heater.

18. The submerged human habitat system for low-gravity, thin-atmosphere planetary surfaces as claimed in claim 1 further comprising:
a controller;
at least one water level sensor;
a power source;
the at least one water level sensor being submerged into the artificial waterbody;
the controller and the power source being mounted within the at least one habitat enclosure;
the at least one water level sensor and the ice-melting system being electronically connected to the controller; and
the at least one water level sensor, the ice-melting system, and the controller being electrically connected to the power source.
